(19) United States
(12) Patent Application Publication
(10) Pub. No.: US 2007/0035735 A1
(43) Pub. Date: Feb. 15, 2007

(54) Sub-image acquistion through scattering media such as smoke and fog

(76) Inventor: Michael D. Cable, Danville, CA (US)

Correspondence Address: John P. Wooldridge, 252 Kaipii PI., Kihei, HI, 96753, US

(21) Appl. No.: 11/061,026

(22) Filed: Feb. 18, 2005

Related U.S. Application Data
(60) Provisional application No. 60/546,431, filed on Feb. 20, 2004.

(51) Int. Cl. G01N 21/00

(52) U.S. Cl. 356/432

(57) ABSTRACT

A concept for improving signal to background for images obtained in a scattering medium such as smoke and fog has been described. This concept can be used to develop instrumentation potentially useful for firefighters or other rescue workers as well as law enforcement and military personnel. Additional applications are use of this technique for operation of vehicles in smoke or fog. This concept can be utilized in conjunction with a variety of other measurement techniques but is most simply envisioned for use with time resolved ballistic and quasi-ballistic imaging.

This application claims priority to U.S. Provisional Patent Application Ser. No. 60/546,431, titled: “Sub-Image Acquisition Through Scattering Media Such As Smoke And Fog,” filed Feb. 20, 2004, incorporated herein by reference.

### BACKGROUND OF THE INVENTION

1. Field of the Invention

The present invention relates to techniques for imaging through scattering media, and more specifically, it relates to methods for improving the signal to background for such techniques.

2. Description of Related Art

Imaging an illuminated object through a scattering medium such as smoke or fog is complicated because the signal returning to a detector is composed of both unscattered photons that have reflected off the object of interest and photons that have scattered off particles in the medium, the latter possibly having never reached the object at all. The image is typically only represented by the unscattered, reflected photons so if the detector cannot distinguish these from the scattered component the image is said to have a lower “signal to background ratio” and the ability to see the object is degraded. The human eye and most simple imaging devices such as photographic and video cameras cannot distinguish the unscattered component and we therefore have difficulties seeing in smoke, fog or other scattering media—the details of the image are lost in the familiar foggy background one sees as smoke or fog increases in density to the point where vision is obscured, particularly in situations where a flashlight or headlights are being used.

In general, the photons reaching the detector that retain the most image information are those that have scattered the least In a situation where the object is illuminated with a light source near the detector, the photons that reach the object and reflect back with no scattering are referred to as ballistic photons. If the light source is pulsed on a time scale that is short compared to the transit time to the object and back, then the first photons to return from the object will be those that have not scattered, since the scattered photons will have traveled longer distances. Thus “ballistic imaging” or “first light imaging” (first light imaging really refers to transmission mode imaging since in reflection mode imaging, scattered photons that did not reach the object can and do return early) utilizes detection of these photons with a time gated or time resolved imaging detector. Quasi-ballistic imaging utilizes the fact that some photons are “minimally scattered”, i.e., they scatter only a few times and each time in a predominantly forward direction. These photons (also sometimes referred to as “snake photons”) also contain considerable image information and techniques using them are similar to ballistic imaging but encompass the slightly later arrival times of the quasi-ballistic component. The following references, which are incorporated herein by reference, describe ballistic and quasi-ballistic imaging: (1) V. Gopal, S. Mujumdar, H. Ramachandran, A. K. Sood, “Imaging in turbid media using quasi-ballistic photons”, Opt. Comm., Vol. 170, pp. 331-345 (1999), (2) M. Kempe, A. Z. Genack, “Ballistic and diffuse light detection in confocal and heterodyne imaging systems”, J. Opt. Soc. Am. A, Vol. 14, No. 1, pp. 216-223 (1997), (3) U.S. Pat. No. 6,515,737, (4) U.S. Pat. No. 5,710,429, and (5) U.S. Pat. No. 5,371,368.

A variety of other techniques that are fundamentally methods for distinguishing unscattered from scattered photons are described in the following references, which are incorporated herein by reference: (1) E. Granot, S. Sternklar, “Spectral ballistic imaging: a novel technique for viewing through turbid or obstructing media”, J. Opt. Soc. Am. A, Vol. 20, No. 8, pp. 1595-1599 (2003) (spectral ballistic imaging), (2) G. Ganesh Chandan, R. M. Vasu, S. Asokan, “Tomographic imaging of phase objects in turbid media through quantitative estimate of phase of ballistic light”, Opt. Comm., Vol. 191, pp. 9-14 (2001), (phase of ballistic photons), (3) U.S. Pat. No. 5,738,101 (four wave mixing for ultrafast correlation time gate), (4) U.S. Pat. No. 5,719,399 and (5) U.S. Pat. No. 5,847,394 (retention of polarization), (6) U.S. Pat. No. 6,233,055 (optical coherence tomography) and (7) U.S. Pat. No. 5,919,140 (Raman scattering). While the details of the measurement techniques vary widely for all these approaches, they all have in common the underlying principle of obtaining an image by distinguishing the unscattered or minimally scattered component of the detected signal.

Another class of techniques for imaging through scattering media involves working with the scattered component of the detected light. In this case, detailed knowledge of the scattering properties of the medium is used to “reconstruct” the object from recorded photon data that does not necessarily contain an image recognizable to the eye. Even though reconstruction techniques are designed to use the scattered photon component, in general they work better if they can be confined to the photons that have scattered least Therefore techniques to distinguish the unscattered component such as those described above are often used in conjunction with reconstruction techniques. Examples of reconstruction techniques applied to imaging through scattering media are shown in the following references, which are incorporated herein by reference: G. Ganesh Chandan, R. M. Vasu, S. Asokan, “Tomographic imaging of phase objects in turbid media through quantitative estimate of phase of ballistic light”, Opt. Comm., Vol. 191, pp. 9-14 (2001); U.S. Pat. No. 5,813,988; U.S. Pat. No. 5,931,789; U.S. Pat. No. 6,064,917 and U.S. Pat. No. 6,148,226.

All of these techniques, as typically implemented, attempt to acquire the entire image in a single field of view. U.S. Pat. No. 6,515,737 describes a particularly easy to understand example where a short pulse of light is used to illuminate an object and a very short exposure (“gated”) image is taken at a time specifically chosen to coincide with the return of the unscattered photons reflected from the object (“gated ballistic imaging”). This provides an enhancement of the unscattered signal to the scattered background described above. It should be noted that it does not necessarily completely eliminate the scattered background as it is entirely possible for photons to scatter around in the medium, never reach the object and then return to the detector at the appropriate time to look like reflected, unscattered signal. Techniques are desirable for further improving the signal to background in this type of imaging as well as for the other techniques described above. The present invention provides such techniques.

### SUMMARY OF THE INVENTION

Objects of the present invention include providing a method and apparatus for acquiring an image through scattering media by collimating sub-images of the image to produce collimated sub-images with reduced scattering effects due to collimation, detecting the collimated sub-images to produce detected sub-images, and reconstructing the image from the detected sub-images.

These and other objects will be apparent based on the disclosure herein.

Many techniques for imaging through scattering media have been published or patented. All of these involve recording the entire image from a single field of view. A new approach is to recognize that there are significant advantages to acquiring an image through scattering media by measuring small parts of the image via multiple measurements (sub-image acquisition). The measurements can either be made sequentially using a single detector or simultaneously using multiple detectors or sub-regions of a larger detector. Advantages of sub-image acquisition include the ability to use much tighter collimation of the source and detector in order to greatly improve signal to scattered background. Working with only part of the image makes reconstruction algorithms simpler and instrumentation expense and complexity may be reduced. The sub-image acquisition approach can be applied to virtually all of the previously described techniques, but is particularly advantageous when utilized with time resolved ballistic imaging.

### DETAILED DESCRIPTION OF THE INVENTION

For the gated ballistic imaging example described above, it is important to realize that the scattered component of the photons arriving at the detector can be returning from a variety of angles relative to the direction of the illumination pulse. These photons, while originally traveling along a line away from the detector toward the object, can scatter away from this line and then upon further scattering take a path that brings them back to the detector. The unscattered ballistic and quasi-ballistic photons of interest, however, return at small angles relative to the illumination axis. Therefore collimating the detector so that only these small angles are detected improves signal to background and this is a technique typically used. However, as conventionally implemented, the angle of collimation cannot be set smaller than that required to obtain the desired field of view.

The proposal here is to carry this collimation further and deliberately restrict the field of view to a smaller portion of the image than is actually required to image the object of interest The entire image is then obtained by taking multiple smaller images to build the desired field of view. By obtaining the image in this “sub-image acquisition” mode, each of the individual smaller images benefits from improved signal to background. In the limit where the scattered component of the signal is large enough that it returns to the detector in a nearly “diffuse” manner, the amount of scattered light detected will be roughly proportional to the solid angle of the detector, so the benefit of increasing collimation will be roughly proportional to the reduction in solid angle. Therefore if the image is obtained in a sub-image acquisition mode using 100 sub-images, the benefit in signal to background can approach a factor of 100. Thus, the present invention provides a method for reduction of background through sub-image acquisition. Note that it is not necessary that the sub-images be obtained at separate times. If multiple detectors are used or sub-regions of a single imaging detector (e.g., a CCD), then well collimated sub-images can be obtained simultaneously.

Working with smaller parts of the image reduces the complexity of image reconstruction as well. Reducing the scattered component of the signal reaching the detector improves the efficacy of virtually all of the previously used techniques described above. And the variation of image conditions in a small sub-image is likely to be much less than that for the image as a whole, thus reducing what is required to obtain a good image.

For situations where the sub-images are obtained sequentially with a small number of detectors or measurement systems, it will be important to acquire each sub-image or single point rapidly enough that the entire image can be obtained in an adequately short exposure time. For most applications the object being imaged will possibly be moving so a short enough total image acquisition time to prevent motion blurring will be required. If movies or video are desirable, even shorter exposures or “frames” should be used. One technique for increasing scan speed is to use multiplexing techniques for both the illumination source and the detector readout.

For the illumination source there is a fundamental limit on how rapidly it can be pulsed in that the signal from a first pulse cannot still be scattering around in the medium at times of interest for an image being obtained from a second pulse. This means that for most applications a second pulse cannot be initiated until a time that is significantly longer than the transit time for a photon to the object and back. In some applications, it will be desirable to pulse more rapidly than this. For these cases, it is possible to multiplex the source by using multiple tagged sources that can be distinguished by one or more detectors. The simplest example of such a tag is photon wavelength. If a second pulse is initiated but the source is at a different wavelength it can be distinguished by a second detector using a filter to make it sensitive to only that wavelength. In this way multiple sources and detectors can be used to achieve a higher scan rate. Thus, embodiments of the present invention multiplex the illumination source.

Readout speed can be another limiting issue. A single detector can often acquire a signal rapidly but then take some time for processing electronics to read out the signal. In this case, it is a fairly common technique to multiplex the readout electronics and/or the processing of the signal that follows. Accordingly, embodiments of the present invention provide multiplexing of the readout electronics and/or the signal processing to increase scan speed.

Scattering media through which it is desirable to image occur in a wide range of situations. Much of the literature on imaging through scattering media is devoted to the specific problem of imaging through tissue for medical applications. This is a particularly difficult problem in that optical densities of interest can be quite high resulting in extremely high levels of scattering. Also, the distances involved require very fast (e.g., picoseconds) time measurements of photons for techniques utilizing gating or time measurements to eliminate scattered background. Thus these tissue-based applications are often referred to as ultrafast imaging.

A more accessible problem by today's technologies is imaging through smoke and fog. These scattering media are typically less optically dense and the distances involved make the required time scales nanoseconds or longer. These types of time measurements are accessible via much simpler instrumentation and technology than that required for shorter distances. In particular, for the single pixel sub-image measurements described above, the detector can be simply a non-imaging photodetector coupled to a transient digitizer. Even for the case of a small, but not single pixel, sub-image, a small array of non-imaging photodetectors coupled to transient digitizers can be used. This technology is simple and inexpensive compared to some approaches for gating imaging detectors such as CCDs, and furthermore, it allows determination of the entire time history of the returned photon signal rather than an image gated at a particular time. This is particularly advantageous when the distance to the object being imaged is not known and therefore the appropriate gating time is unknown. The present invention includes the application of non-imaging technologies to sub-image acquisition.

An example of a device suitable for sub-image acquisition where the image is acquired all at once (as opposed to scanning mode) is an array of collimators defining multiple sub-regions of the image. Such a device could potentially work with either an illumination source or via ambient light Photons entering the collimators could be detected either by an array of individual detectors or could be imaged with a larger imaging detector. The photon signal levels will likely be quite low and require signal amplification. For the imaging case, this might be achieved with an image-intensified CCD similar to those used in night vision applications.

An example illustrating sub-image acquisition in a scanning mode is a device to image through smoke or fog at distances greater than 1 m. Envisioned applications are rescue equipment for use in smoky environments (relevant distances 3-10 m) or imaging systems for use in driving or operating other moving vehicles (relevant distances 10-1000 m).

For the rescue device, the detector can consist of a single photodiode or photomultiplier tube and a transient digitizer with 1 GHz response. The view angle of the detector would be made to coincide with the axis of an illuminating pulsed laser that emits repetitive 1 ns wide pulses. The laser and detector view angles could be scanned by mechanical movement of an optical component such as a mirror. In order to increase scanning speed, multiple detectors and lasers operating at different wavelengths could be used. Or instead of working in single pixel mode, a small array (e.g., 3×3) of photodiodes and transient digitizers could be used to acquire a small sub-image rather than a single pixel.

Readout of this device would result in a time history for the returned pulse at each pixel in the single pixel scanning mode case. Simply constructing an image at each time point will provide the equivalent of a series of gated ballistic images. More complex reconstruction algorithms can be used to compensate more fully for scattering effects. In this case, it might be beneficial to use additional detectors looking at angles other than straight along the illumination axis.

In any of these schemes, it is beneficial to have the entire time history of the returned signal. This allows at least two potential modes of operation. The first would be a “fixed focus” type of mode where a particular distance to the object is set and an image determined and displayed for a time corresponding to that distance. The second mode envisioned is a “scanning focus” mode where an image is determined at each time point in the time history and the corresponding distance to any object detected at a particular time is now known. Image processing techniques can be used to automatically detect the presence of objects at various times and a composite image composed of objects found can be created. Distance information for objects found can be used to give depth information not always available in other imaging technologies.

For the driving or vehicle operation application, the concepts are similar except that the distances of interest are probably somewhat larger and the requirement for movies or video is a must. Where a single frame image or perhaps a very slow series of images might be acceptable for walking through a smoky environment, driving would require scanning speeds high enough for real-time movies. This means that the concepts of multiplexing and working with sub-images rather than single pixel scanning are important for this application.

The foregoing description of the invention has been presented for purposes of illustration and description and is not intended to be exhaustive or to limit the invention to the precise form disclosed. Many modifications and variations are possible in light of the above teaching. The embodiments disclosed were meant only to explain the principles of the invention and its practical application to thereby enable others skilled in the art to best use the invention in various embodiments and with various modifications suited to the particular use contemplated. The scope of the invention is to be defined by the following claims.

We claim:

1. A method for acquiring an image through scattering media, comprising:
collimating sub-images of said image to produce collimated sub-images with reduced scattering effects due to collimation;
detecting a plurality of said collimated sub-images to produce detected sub-images; and
reconstructing said image from said detected sub-images.

2. The method of claim 1, wherein the step of detecting a plurality of said collimated sub-images comprises using a single detector.

3. The method of claim 1, wherein the step of detecting a plurality of said collimated sub-images comprises using multiple detectors.

4. The method of claim 1, wherein the step of detecting a plurality of said collimated sub-images comprises using subregions of a detector.

5. The method of claim 1, utilized with time resolved ballistic imaging.

6. The method of claim 1, wherein the step of collimating sub-images of said image comprises setting the collimation of said sub-images to only allow detection of ballistic photons of interest.

7. The method of claim 1, wherein the step of collimating sub-images of said image comprises setting the collimation of said sub-images to only allow detection of ballistic and quasi-ballistic photons of interest.

8. The method of claim 1, further comprising providing at least one illumination source.

9. The method of claim 8, wherein said at least one illumination source comprises a plurality of illumination sources, the method further comprising multiplexing said plurality of illumination sources.

10. The method of claim 1, wherein the step of detecting a plurality of said collimated sub-images is carried out using plurality of detectors, the method further comprising multiplexing said detectors.

11. An apparatus for acquiring an image through scattering media, comprising:
means for collimating sub-images of said image to produce collimated sub-images with reduced scattering effects due to collimation;
means for detecting a plurality of said collimated sub-images to produce detected sub-images; and
means for reconstructing said image from said detected sub-images.

12. The apparatus of claim 10, wherein said means for detecting a plurality of said collimated sub-images comprises a single detector.

13. The apparatus of claim 10, wherein said means for detecting a plurality of said collimated sub-images comprises multiple detectors.

14. The apparatus of claim 10, wherein said means for detecting a plurality of said collimated sub-images comprises using subregions of a detector.

15. The apparatus of claim 10, coupled with means for time resolved ballistic imaging.

16. The apparatus of claim 10, wherein said means for collimating sub-images of said image only allows detection of ballistic photons of interest.

17. The apparatus of claim 10, wherein said means for collimating sub-images of said image only allows detection of ballistic and quasi-ballistic photons of interest.

18. The apparatus of claim 10, further comprising at least one illumination source.

19. The apparatus of claim 18, wherein said at least one illumination source comprises a plurality of illumination sources, said apparatus further comprising means for multiplexing said plurality of illumination sources.

20. The apparatus of claim 10, wherein said means for detecting a plurality of said collimated sub-images comprises a plurality of detectors, the apparatus further comprising means for multiplexing said detectors.
